(19) United States
(12) Patent Application Publication
(10) Pub. No.: US 2011/0231321 A1
(43) Pub. Date: Sep. 22, 2011

(54) METHOD AND APPARATUS FOR PROVIDING PREDETERMINED PROMOTIONAL OFFERS

(75) Inventor: Adam E. Milne, Portland, OR (US)

(73) Assignee: ZAPHOUR, INC., Portland, OR (US)

(21) Appl. No.: 13/046,645

(22) Filed: Mar. 11, 2011

Related U.S. Application Data
(60) Provisional application No. 61/314,524, filed on Mar. 16, 2010.
(60) Provisional application No. 61/366,901, filed on Jul. 22, 2010.
(60) Provisional application No. 61/372,787, filed on Aug. 11, 2010.

(51) Int. Cl. G06Q 30/00

(52) U.S. Cl. 705/80; 705/14.49; 705/14.58; 705/14.66

(57) ABSTRACT

Embodiments provide methods, apparatus, systems, and computer readable media associated with provisioning of promotional offers from merchants to consumers. Merchants may submit schedules to a promotional offer provision service. The schedules may describe promotional offers which are usable during specific pre-determined time periods. The schedules may also describe other aspects of the promotional offers, such as type of offer or discount, and may include restrictions, such as restrictions based on a consumer's history of follow-through. Consumers may search the system, such as through a website, for offers of interest. Consumers may search based on criteria such as time and location. If the consumer accepts the offer, he or she may be provided a coupon with a unique code for presentation to the merchant. The consumer may also negotiate terms of the promotional offer, if desired. Other embodiments may be described and claimed.

### RELATED APPLICATIONS

The present application claims the benefit of: 1) U.S. Provisional Application 61/372,787, filed Aug. 11, 2010 and entitled “Method and Apparatus for Providing Predetermined Promotional Offers”; 2) U.S. Provisional Application 61/366,901, filed Jul. 22, 2010 and entitled “Method and Apparatus for Providing Predetermined Discount Offers”; and 3) U.S. Provisional Application 61/314,524, filed Mar. 16, 2010 and entitled “Method and Apparatus for Providing Predetermined Discount Offers.” Each application is hereby incorporated by reference in its entirety.

### BACKGROUND

Currently, industries and services seek to gain customers through the use of promotional offers, such as discounts or coupons. By providing these offers to potential consumers, merchants may bring more people into their establishments and/or introduce potential customers to new products or services.

However, many current discounts or coupon schemes provide only limited utility to merchants. For example, current promotional offers do not address all issues that merchants face with varying amounts of activity at their business. There are a number of industries that have a time period during the day that is substantially busier than others. For example, restaurants and bars experience what are known as “rushes” or peak times, such as, for example, at a dinner hour. Other industries and businesses, such as salons, movie theaters, bowling allies, golf courses, and many others also experience busy times and/or slower times.

Existing promotional techniques fail to address these concerns as they provide offers or discounts that are too broad to address merchants' needs. For example, under existing schemes, discounts are frequently for a 24-hour period or longer. Additionally, the discounts, by covering such long periods, can cause discounted patrons to compete with full-price customers arriving during a given time period.

Current promotional offers also suffer from a lack of information regarding who will use them and how. For example, many promotional offers offered by merchants exist in large or limitless supply because it is difficult to determine who will acquire the discounts. Additionally, many of these discounts are distributed widely and in such variety that there is little consistency amongst the discounts in the marketplace. It is difficult for merchants to know who is acquiring their promotional offers, whether the offers are effective for their intended clientele, and whether the offers are being used in an efficient way. Additionally, many existing discounts, offers, and happy hours are very confusing. Offers may vary from “a free appetizer”, “buy a slice of pizza get a coke free”, “10% off”, and “buy one get one free,” which can be confusing to the consumer.

### BRIEF DESCRIPTION OF THE DRAWINGS

FIG. 1 illustrates a block diagram of example components of a promotional offer provision system;

FIG. 2 illustrates a block diagram of a first example schedule for a restaurant;

FIG. 3 illustrates a block diagram of a second example schedule for a merchant;

FIG. 4 illustrates an example process for providing promotional offers to a consumer;

FIG. 5 illustrates an example process for receiving a merchant schedule;

FIG. 6 illustrates an example process for displaying promotional offers to a consumer;

FIG. 7 illustrates an example display of a promotional offer search;

FIG. 8 illustrates an example display of a selected promotional offer;

FIG. 9 illustrates an example process for providing a promotional offer to a consumer;

FIG. 10 illustrates an example process for a consumer using a promotional offer; and

FIG. 11 illustrates an example computing system configured to practice various aspects of the earlier described processes.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent. In various embodiments, one or more of the illustrated operations may be merged or combined into other operations, or may be divided into additional operations.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In various embodiments, methods, apparatuses, and systems for providing predetermined promotional offers, such as discounts, are provided. In exemplary embodiments, a computing device may be endowed with one or more components of the disclosed apparatuses and/or systems and may be employed to perform one or more methods as disclosed herein.

Embodiments described herein offer merchants a mechanism for creating hour-by-hour schedules for promotional offers, which may be searched by consumers. More specifically, various embodiments herein may allow a business to: (a) create a pre-determined promotional offer, (b) create a promotional offer in a limited quantity/supply, (c) create an offer valid for a specific time period of the day, such as off-peak hours, (d) create an offer that may have common traits with promotional offers from other establishments, (e) restrict the offer to only being served to consumers that have a historical level of online commitment, and/or (f) provide for discounts to become activated once a predetermined number of people, such as from a consumer's social network, agree to participate in a promotional offer. In various embodiments, consumers may access these offers through web-based applications (or dedicated applications) to search through the offers. In various embodiments, consumers may search based on a time, such as by searching for offers which are currently available to be used, or offers which will be available at a future time. In various embodiments, consumers may be displayed various offers, such as on a map; in various embodiments, the consumers may therefore view offers that are available near their current locations.

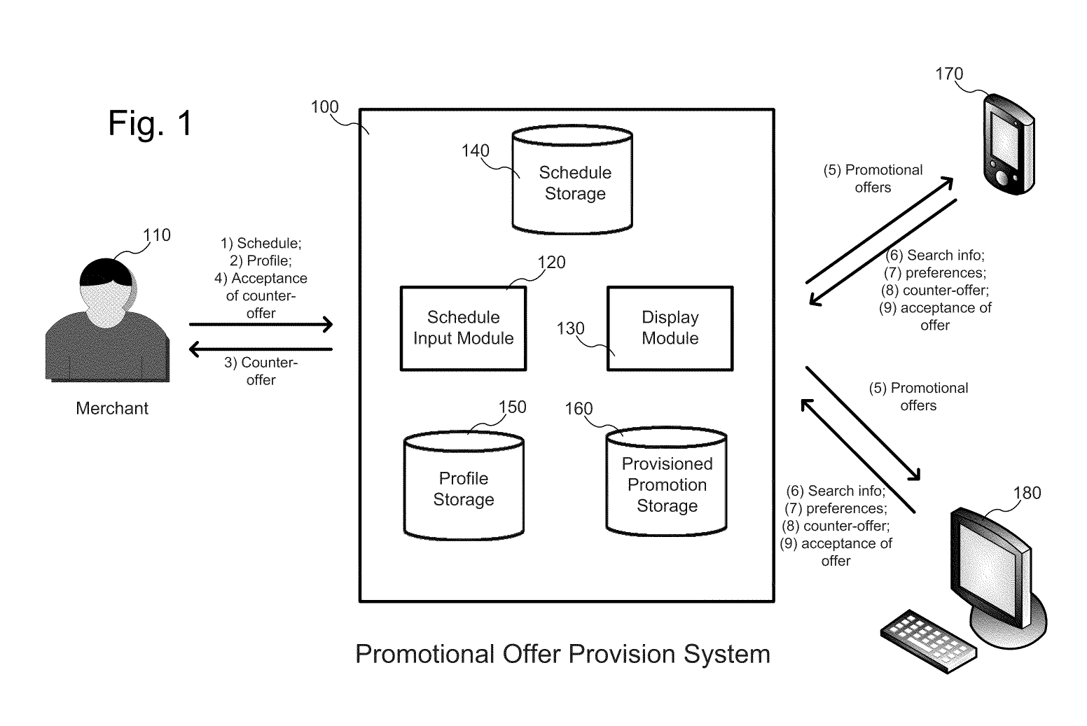

FIG. 1 is a block diagram of selected components and data flows for a promotional offer provision system 100 in accordance with various embodiments. It may be noticed that, while FIG. 1 illustrates specific components of the promotional offer provision system 100 and shows them combined under a single entity, in various embodiments, the modules and storage units illustrated therein may be separated, divided into additional entities, or merged. The data flows and interactions illustrated may be performed through various communications pathways, such as through the Internet, WAN, LAN, Ethernet, WiFi, Bluetooth, or other wired or wireless communication protocols.

In FIG. 1, the promotional offer provision system 100 interacts with a merchant 110. As discussed below, in various embodiments, the merchant may interact with the promotional offer provision system 100 to input (data flow 1) one or more schedules for promotional offers the merchant wishes to provide to consumers. In various embodiments, the merchant may perform this input to the promotional offer provision system 100 through the illustrated schedule input module 120, as will be described below. In various embodiments, the promotional offer provision system 100 may then store the received schedule in the schedule storage 140. In accordance with various embodiments, the schedule storage may comprise a database, hard drive, removable storage media, or other storage device. The merchant 110 may also create and maintain a profile (data flow 2), which may be stored on the profile storage 150. Additionally, the merchant may receive counter-offers of based on promotional-offers provided to consumers (data flow 3), and may provide acceptance of the counter offer (data flow 4).

FIG. 1 also illustrates a display module 130, which may interact with consumers, such as through a mobile phone (or other mobile device) 170 or through a desktop computer 180. In various embodiments, the interaction provided between consumers and the promotional offer provision system 100 may be performed through a web browser, such as through an interactive web page served by or at the direction of the display module. In other embodiments, the interaction provided between consumers and the promotional offer provision system 100 may be performed through a dedicated application or mobile application executing on the mobile device 170 or the desktop computer 180 which interacts with the display module 130.

In various embodiments, the display module 130 serves to provide (data flow 5) promotional offers to consumers through their mobile device 170 or desktop computer 180. The consumers may likewise provide the promotional offer provision system 100 with information, such as search terms (data flow 6), preferences for promotional offers (data flow 7), counter-offers to offers provided by the promotional offer provision system 100 (data flow 8), and/or indications of acceptance of an offer (data flow 9). Information specific to provisioned promotional offers, such as those accepted by consumers, may be stored in the provisioned promotion storage 160. In various embodiments, interactions and communications between consumers and the display module may happen within the website or web page of another entity, such as through a “widget” served by the display module as part of the website or web page. In various embodiments, all or part of the communications described herein may be provided through the widget, and the widget may provide a facility for connecting to a dedicated interface, such as the aforementioned web page on a web browser or interface on an application.

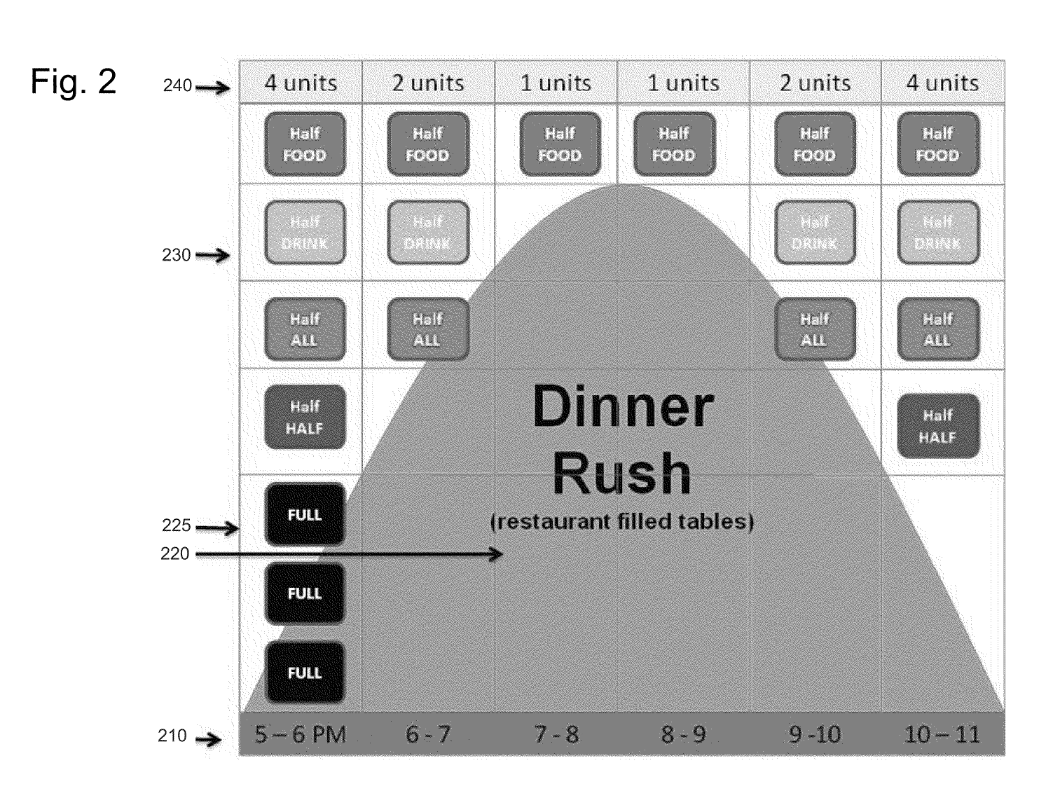

FIG. 2 is an example of a schedule illustrating the utility of varying promotional offers according to the hour of day. In various embodiments, the schedule input module 120 may provide a mechanism for a merchant to describe one or more promotional offers using an interface similar to the one illustrated at FIG. 2, or another interface, form, etc. In the illustrated example of FIG. 2, the merchant is a restaurant which has seven tables, or “units.”

As illustrated, the schedule may vary on an hour-by-hour basis, such as illustrated by the hourly schedule 210, which shows various time periods during a particular day. These may also represent hours of operation for the business on a particular day. In various embodiments, a different schedule may be created for different days. For example, the merchant may run different operational hours on different days of the week. In another example, the merchant may know that he or she is more or less busy at different times on different days of the week. In yet another example, the merchant may prepare for specific busy or slow dates of the year using alternative schedules.

As FIG. 2 also illustrates, a merchant may have a specific filled capacity that he or she predicts will occur at specific times during a particular day. Thus, as illustrated, a dinner rush illustrated as area 220, may start at 5:00 PM, ramp up to peak at 8:00 PM, and then slow back down. From this rush, the merchant may know that he or she will see a certain amount of capacity at a given time. For example, between 5:00 and 6:00 PM, the merchant may feel he or she can safely assume that three units will be full in the restaurant, as illustrated by full unit markers 225. The merchant may then assume that he or she will have four available units during that time period, as illustrated by the available unit markers 230. This is also illustrated in the running total of available units 240 at the top of FIG. 2.

The promotional offer provision system 100 may then facilitate the merchant in determining and scheduling some number of the four non-filled tables to offer at a discount. In the example, of FIG. 2, the merchant has chosen to offer one discount promotional offer of half-off food prices, one with half-off drink prices, one with half-off all food and drink, and one “half half” which adds a half-again discount to a traditional half-off discount, to result in a total 75% discount. In various embodiments, the merchant may allot promotional offers by identifying a ranking of the orders, such that promotional offers which cost the merchant less money are provided to consumers first, such as the first one that only offers half-off food. If more available units exist, then those may be filled by more-expensive promotional offers. In various embodiments, the merchant may decide to offer fewer than all of the available units at a discount, or to offer every available unit at a discount.

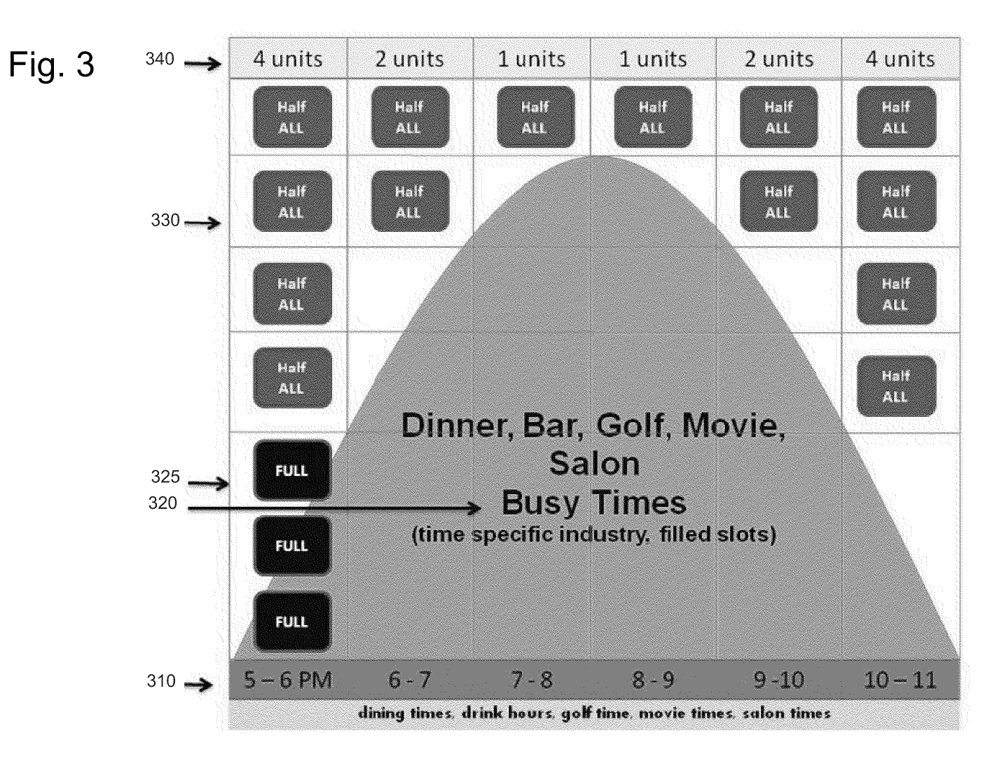

In various embodiments, the promotional offer provision system 100 may operate with various industries or businesses. For example, restaurants, bars, movie theaters, bowling allies, golf courses, salons, and others may utilize embodiments found herein. FIG. 3 shows an example schedule which may apply to one or more of these other industries:

Similar to the illustration of FIG. 2, the illustrated schedule of FIG. 3 is divided into various time periods during a particular day, representing hours of operation for the business. FIG. 3 also illustrates that capacity may be filled during a busy time 320, resulting in full units, represented by full unit markers 325. As in the schedule above, the schedule of FIG. 3 shows that various numbers of units may be available, such as illustrated by available unit markers 330. The quantity of available units is illustrated as the running total of available units 340.

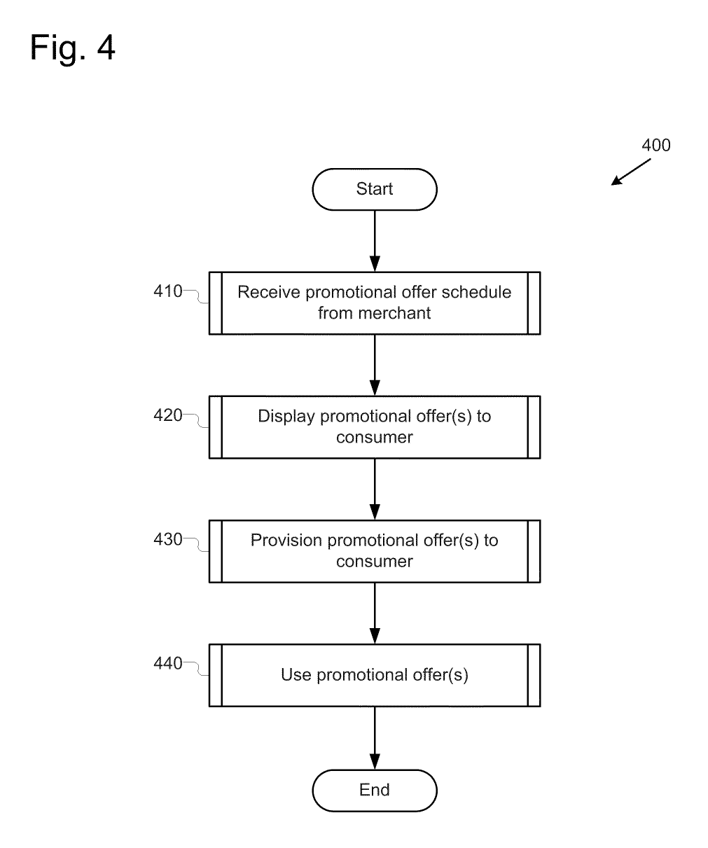

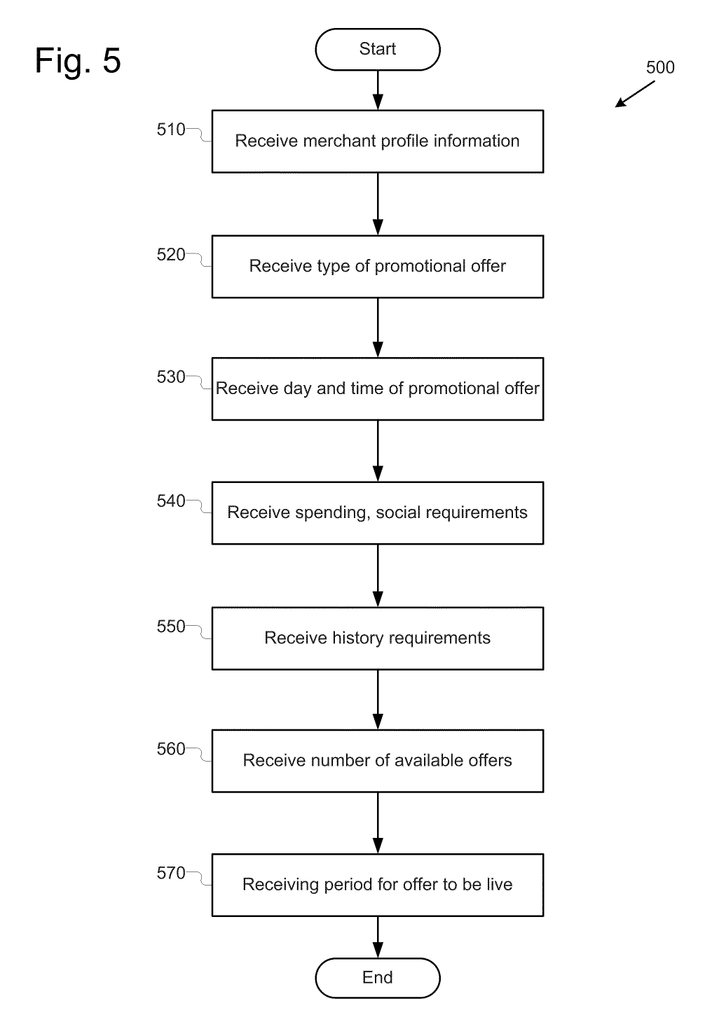

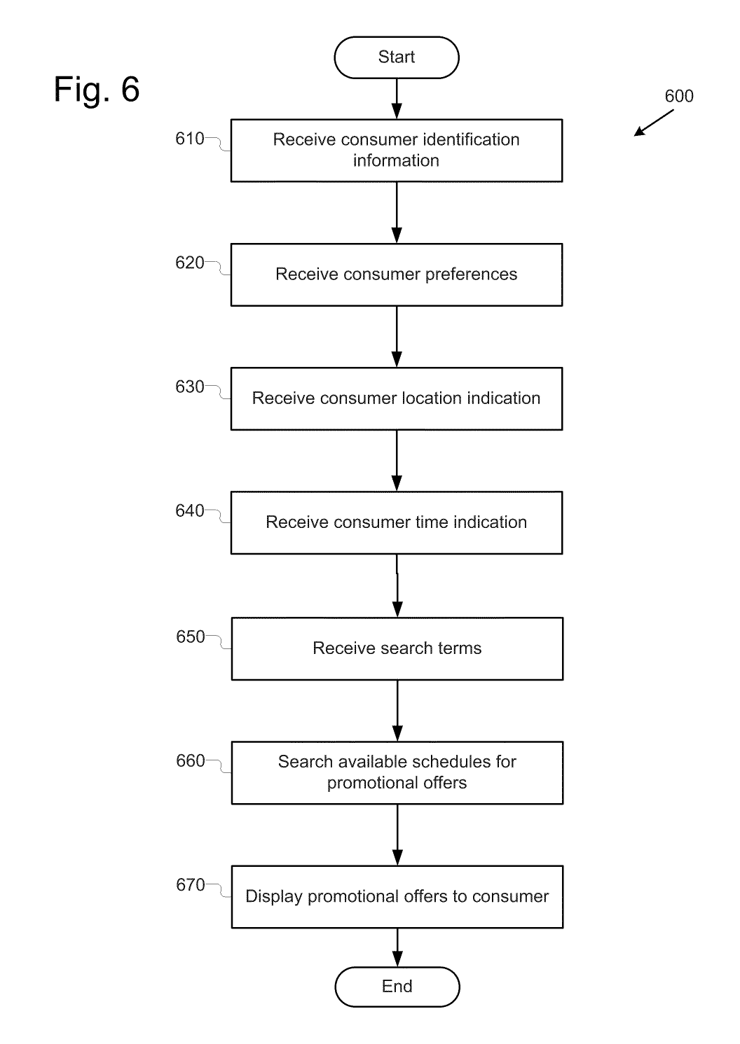

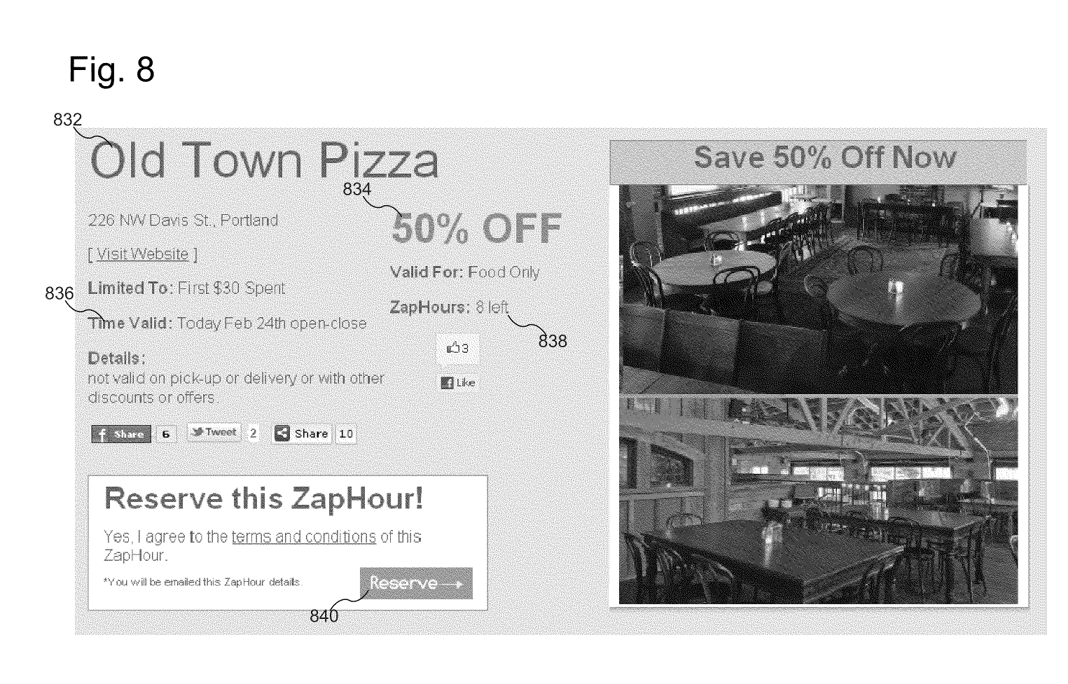

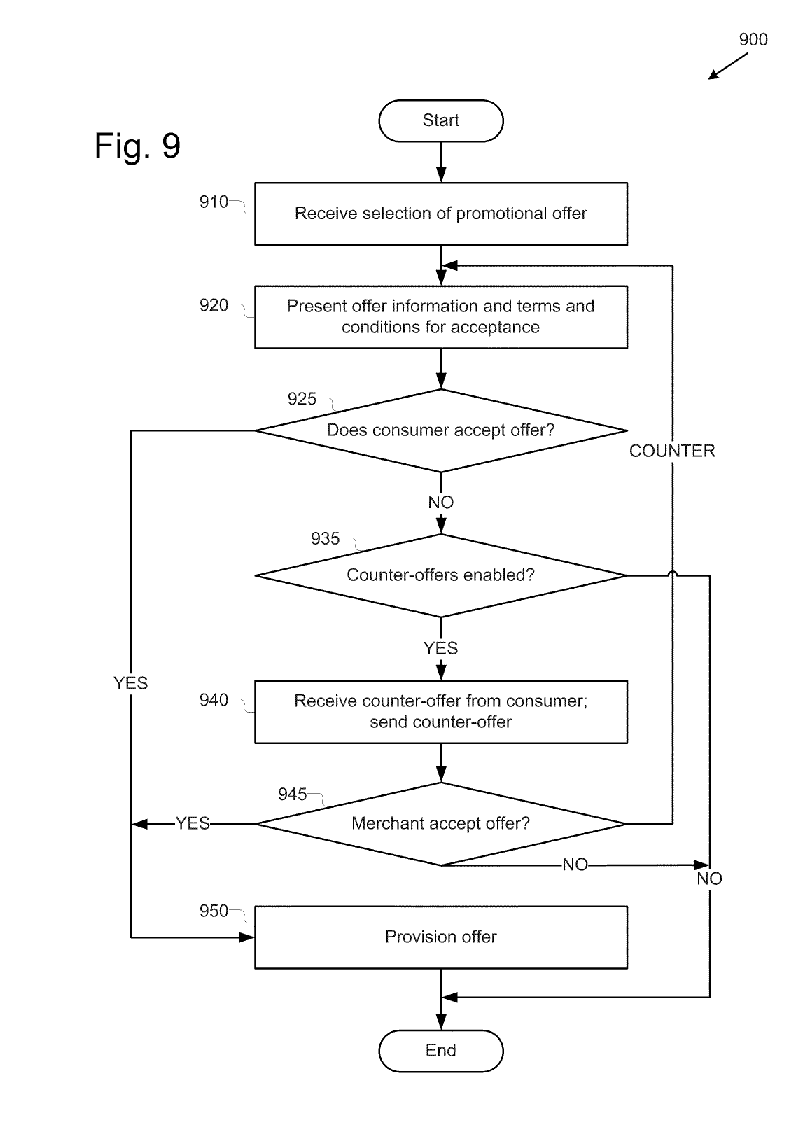

FIG. 4 illustrates an example process 400 for promotional offer provision system 100 to provide promotional offers to a consumer in accordance with various embodiments. The process may begin at operation 410, where the schedule input module 120 of the promotional offer provision system 100 may receive one or more promotional offer schedules from a merchant. The process is described in greater detail below with respect to FIG. 5. At operation 420, the display module 130 of the promotional offer provision system 100 may display one or more promotional offers to a consumer for consideration, such as in response to a search request. The process is described in greater detail below with respect to FIG. 6. At operation 430, the display module 130 of the promotional offer provision system 100 may provision one or more promotional offers accepted by a consumer. The process is described in greater detail below with respect to FIG. 8. At operation 440, the one or more promotional offers may then be used by a consumer. The process is described in greater detail below with respect to FIG. 9.

FIG. 5 illustrates an example process 500 for the schedule input module 120 of the promotional offer provision system 100 to receive one or more promotional offer schedules from a merchant in accordance with various embodiments. In various embodiments, the process of FIG. 5 may take place, at least in part, on an interface similar to the schedules illustrated at FIGS. 2 and 3. The process may begin at operation 510, where the schedule input module 120 may provide a profile information interface (not illustrated) to the merchant and may receive profile information from the merchant. In various implementations, the profile information may include information about the merchant's business or businesses, such as username and password, contact information for receiving and sending messages to the system, keywords or phrases describing the business/businesses, and/or information regarding general availability of units at the business. In some embodiments, operation 510 may not take place every time the merchant chooses to enter or modify schedule information with the schedule input module 120 and/or may involve general information that is unrelated to a specific schedule.

At operation 520 the schedule input module 120 may receive information indicating a type of promotional offer the merchant wishes to provide. In various embodiments, the schedule input module may provide pre-generated promotional offers for the merchant to choose from. In such embodiments, a standardized offer structure may be used. In one example, promotional offers may include discounting choices which each comprise variants on the language of “half off” In one such example, the possible discounts may be (a) half off—50% off, (b) half of half off—25% off, or (c) double half off—75% off. In various embodiments, the type of service or product to which the promotion is applied may also be standardized. For example, for merchants who own restaurants and bars, the schedule input module 120 may provide options to choose from (a) food, (b) drinks, or (c) all products. In another example, other product categories may be used, such as types of apparel (e.g., “boys' jeans,” “formal wear”), electronics (e.g. “mobile devices,” “business software”), or services (e.g. “chair massage,” or “tax consulting”).

In various embodiments, promotional offers may be associated with premium membership or a positive participation history. For example, a merchant may offer consumers the ability to view a promotional offer in advance if the consumer is a participant in a rewards program or has taken advantage of multiple offers in the past. In another example, a promotional offer may be associated with a promotional point program. Thus, in one embodiment, use of a promotional offer may require that a consumer have a certain number of points earned. In another, use of a promotional offer may provide promotional points to a consumer.

In various embodiments, a merchant may associate promotional offers with other merchants. For example, a merchant may choose to participate in a group event where consumers are given promotional offers for multiple merchants to use over a particular time period. In another embodiments, a merchant may associate usage of a promotional offer with a particular other merchant; for example a consumer that selects a restaurant's promotional offer for a happy hour promotion may also be offered a promotional offer for use at a nearby club for after-dinner dancing.

In alternative embodiments, the schedule may describe categories or types for which the promotional offer is not to be applied. For example the schedule may indicate that an offer is valid for “all purchases except alcohol” or “all items except jewelry.” Other examples of standardization of promotional offers may include discounts in increments of 10%, or other methods in which choices of promotional offers are similarly limited to assist with standardization. Other embodiments may include non-standardized offers.

At operation 530 the schedule input module 120 may receive information from the merchant indicating a day and time for a promotional offer. Thus, in the example of FIG. 2, the merchant may indicate that a half-off food promotional offer should be provided at all times, or half-off all food and drinks be offered between 5:00 PM and 7:00 PM and again between 9:00 PM and 11:00 PM. As discussed above, in an alternative embodiment, the merchant may simply indicate times he or she wishes to provide promotional offers at operation 520 but, instead of specifying particular offers to go with times he or she may rank types of offers. In this way, the offers may be chosen by the promotional offer provision system 100 according to the number of units that are available and the order indicated by the merchant.

At operation 540, in one embodiment, the merchant may indicate spending requirements on the promotional offer, such as minimum and maximum dollar amounts for a consumer to spend. In another embodiment, the merchant may indicate social requirements, such as that a certain number of others, such as friends or associates of a consumer, must join in for the promotional offer to be active. For example, the merchant could require that a minimum of ten people, and/or no more than twenty, accept an offer before the promotional offer may be used. In various embodiments, websites such as Facebook.com or Twitter.com may be used to allow friends of a consumer to participate in joint digital activities. In various embodiments, the system 100 may record whether a consumer accepting a promotional offer with requirements has satisfied those requirements.

At operation 550, the schedule input module 120 may receive information from the merchant describing particular requirements on the history of a consumer if he or she is to be allowed to use the promotional offer. This history may comprise information such as how many times a consumer has been a “no-show” (e.g., the consumer has accepted a promotional offer but does not show up to the merchant's business to use it). In other examples, the history may show whether the consumer followed through with spending limits described in an offer or whether a consumer followed through with a promise to bring a number of people as requested in the promotional offer. In another embodiment, the promotional offer provision system 100 may develop a credibility metric for a consumer which gives a general idea of how often that consumer has followed through on his or her agreements with this or other merchants. In other embodiments, the schedule may place requirements on or consider consumers' preferences and purchase habits. For example, the schedule may make its promotional offer contingent on a consumer showing a history of using offers in a particular merchant category, at a particular time of day. In another example, the schedule may require or prefer a consumer who has used an offer a minimum number of times, over a described time frame, within a recent period of time, or near a particular location. In one such example, a schedule may require that, to be shown an offer, the consumer should have previously used a promotional offer for pizza, used it more than five times, had at least one of those uses in the last week, and that the consumer be in a specified neighborhood.

At operation 560, the schedule input module 120 may receive information from the merchant indicating a number of promotional offers which are available or offered to consumers. In some embodiments, this number may be determined based on, in part, the number of available units the merchant indicates should be used for providing offers. In one example, the promotional offer provision system 100 may determine that for each available unit, a certain number of promotional offers should be provided, assuming that some or most of those that receive the offer will not follow through. In another example, the promotional offer provision system 100 may determine that fewer promotional offers should be provided than there are available units, such as if the merchant wishes to always leave some units open.

At operation 570, the schedule input module 120 may receive information from the merchant indicating how far in advance to make a particular promotional offer live. For example, the merchant may indicate that the promotional offer is only available on the same day that it can be used, in order to target only motivated consumers who are searching for immediate opportunities. In another example, the merchant may wish for an offer to only be made available during the time period for which it is open, to encourage use by people searching for offers and using them in real time. In another example, the merchant may wish for an offer to stop being provided to consumers in advance of the date or time it is good for. In other embodiments, the merchant may also indicate whether he or she would like the ability to offer more discounts in an on-the-fly manner, such as during slow times. The process may then end.

FIG. 6 illustrates an example process 600 for the display module 130 of the promotional offer provision system 100 to display promotional offers to consumers in accordance with various embodiments. The process may begin at operation 610, where the promotional offer provision system 100 receives consumer identification information. In one embodiment, the promotional offer provision system 100 may receive login information from a consumer. In another, a consumer may create a profile with the promotional offer provision system 100, which is then associated with login information or with other identifying information, such as a cookie on the consumer's mobile device or desktop computer.

At operation 620, the promotional offer provision system 100 may receive preferences from a consumer. In one embodiment, the preferences may be received when the consumer creates a profile. In another embodiment, the preferences may be received when the consumer browses or searches for promotional offers for himself or herself to use. Such preferences may be extracted or determined from the user's search history or behavior. Examples of consumer preferences may include types of merchants to display, types of offers, whether the promotional offer provision system 100 should include social networking aspects when displaying offers, geographical search limits (such as a distance from a consumer's current or favorite location(s)), favorite merchants, and others.

At operation 630, the display module 130 of the promotional offer provision system 100 may receive an indication of a location from the consumer. In one embodiment, the consumer may be prompted by the display module to enter an address so the promotional offer provision system 100 can search near that address. In another embodiment, the consumer's current location may be determined by a GPS device or sensor, such as in a mobile device or dedicated GPS console.

At operation 640, the display module 130 of the promotional offer provision system 100 may receive an indication of a time preference from the consumer. In one embodiment, the indication of the time preference may be an indication that the search is to be performed with reference to the current time. In another embodiment, the indication of the time preference may be an indication that the search is to be performed with reference to a future time.

At operation 650 the display module 130 of the promotional offer provision system 100 may receive one or more search terms from the consumer to use when searching for and displaying promotional offers. Examples of search terms may include types of fare (e.g., “Mexican” or “New American”), types of merchant (e.g. “pub,” “restaurant,” “movie theater”), terms relating to events or meals (e.g. “Valentine's Day” or “brunch”), and/or terms relating to types of promotional offers (e.g., “buy one get one free,” “half-off food’).

At operation 660, the display module may search schedules entered by merchants for promotional offers that are relevant to the consumer. In various embodiments, the display module 130 may search the schedule storage 140 for schedules. In various embodiments, the display module 130 may limit its search based on time periods identified for various promotional offers in the schedules. In various embodiments, the display module 130 may limit its search to only those promotional offers which are indicated as “live” by the merchants, such as from the information entered at operation 570. In addition, in an embodiment, only those “live” or currently active/available promotional offers may be displayed to the consumer to provide a real-time view of available offers.

In various embodiments, the display module 130 may limit its search based on the indication of time given by the consumer, such as in at operation 640. Thus, in one embodiment, the display module 130 may limit its search based on a current time contemporaneous with the search. In such an embodiment, the display module 130 may display promotional offers which can currently be used. For example, the display module 130, when searched at 4:45 PM, may display a nearby promotional offer which can be used on the day of the search between 4:00 and 6:00 PM. In some embodiments, the display module 130 may display promotional offers which will be open within a predetermined time period. In various embodiments, the predetermined time may be indicated by the consumer, such as in his or her preferences. In other embodiments, the predetermined time may be set by the merchant or by the promotional offer provision system 100.

In various embodiments, the display module 130 may limit searching on schedules with limited numbers of promotional offers to those schedules for which one or more promotional offers are still available. At operation 670, the promotional offers which are found to be relevant and live are displayed to the consumer.

In some embodiments, search terms may be entered or identified to trigger a future alert, and the consumer may be notified when a promotional offer satisfying the desired search terms is provided. For example, a consumer could indicate that he or she wants to be notified when a promotional offer is made available by a particular merchant, or a particular area, or at a defined discount, and display module 130 may provide a display or message, etc., capturing the consumer's attention, and notifying the consumer that such an offer is available. In some embodiments, the creation of an alert may allow the system 100 to present promotional offers to a consumer at times other than when the consumer has requested a search.

In various embodiments, promotional offers associated with an alert may be displayed, filtered, or ordered for a consumer based on one or more alerts that the consumer has previously indicated. Thereafter, when the consumer performs a search, promotional offers from that merchant may be placed higher on the list, or using graphical effects which make them more noticeable to the consumer. In various embodiments, the alert may be generated based on preferences, such as those discussed above with respect to filtering, rather than from search terms.

In various embodiments, the display module may perform filtering of promotional offers based on consumer preferences. For example, in various embodiments, the consumer may desire to see only merchants of a certain type (e.g. Italian restaurants). In other embodiments, the consumer may indicate that he or she wishes to filter out promotional offers, or merchants, whose wares or services fall outside of a certain monetary range. In some embodiments, the consumer may indicate that he or she only wishes to see promotional offers which fall within a certain geographic area, or which are within a particular distance from the location indicated above. In various embodiments, these filtering preferences may differ from search terms entered by the consumer, as they may not require the consumer to re-enter them on a per-search basis. Instead, the preferences may be maintained by the system 100, or on a local device, to perform the filtering without additional input by the consumer.

In alternative embodiments, the display module may not receive search terms to search for promotional offers. Instead, the display module 130 may display results based entirely or primarily on consumer location and/or time periods. In another embodiment, the display module may display promotional materials without consumer input, such as, for example by displaying all promotional offers which may be used at the time of the display or within a certain time period of performing the display.

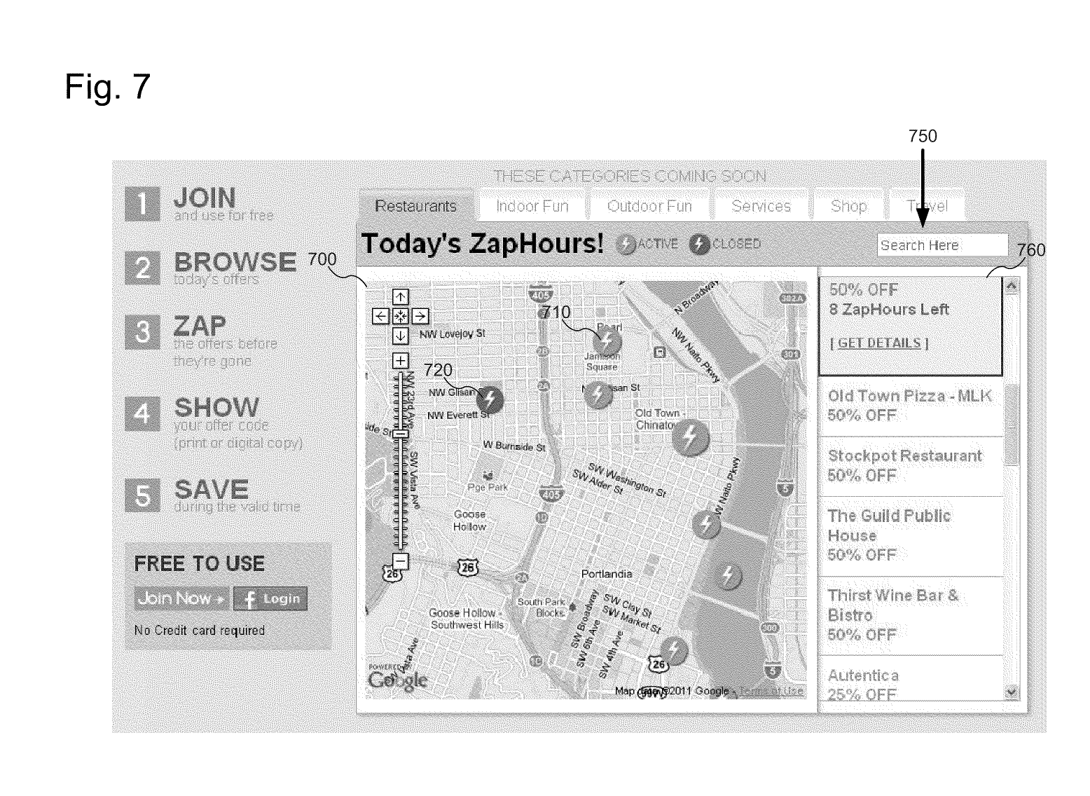

FIG. 7 illustrates an example screen image of such a search result created by the display module 130. In the illustrated embodiment, the search result screen shows a map 700, which illustrates a portion of a city, centered on a consumer location. The consumer location may be marked by a suitable icon, graphic, or image, such as a pin, star, graphic of a person, avatar, photograph of the consumer, etc. In other embodiments, a list or other graphical view of the search results may be presented. As discussed above, in various embodiments, the display module may present the search result on a mobile device and/or a desktop computer and may use a web browser or a dedicated application.

The map 700 also shows icons 710 and 720 representing various promotional offers. In various embodiments, any suitable marker or indicator may be used on the map to identify merchants. In one embodiment, a specialized icon may be used, such as the lightning bolt logo used in the example of FIG. 7. Specific icons, colors, effects etc. may be used to indicate the amount and/or type of the discount. For example, different lightening bolt icons may be used to indicate different types or amounts of discounts. For example, a map may show icons representing 50% off offers, with other icons (such as displayed in a different color) representing 25% off offers. In other embodiments, a map may show icons of different colors representing merchants with active or inactive offers, such as a colored icon representing a merchant with an active, open offer 710, and a grey icon representing a merchant with a closed offer 720. In other embodiments, a map may show icons of different colors representing merchants with active or inactive offers. Alternatively, the particular merchant's logo or trademark may be used as the icon. In other examples, effects such as flashing may be used, such as to indicate a particular interest level of a promotional offer, or simply to denote that time is running out on an offer.

In various embodiments, the promotional offers represented by the icons may be displayed for a consumer after the consumer clicks or otherwise indicates that he or she wishes to view the contents of the offer. As discussed above, in various embodiments, the search result may comprise a list view such as list 750. In various embodiments, the list view may either be shows as a replacement for a map view, or in addition to the map view, as in the screen image of FIG. 7. In various embodiments, such as the embodiments illustrated, selection of an icon on the map may result in highlighting or other selection of a list element, such as highlighted list element 760. In various embodiments, the result page may not comprise search results, but may instead offer a consumer the mechanism to sort through and/or to filter promotional offers. Such sorting and filtering may be performed either on a map or a list display according to various embodiments.

Selection of an offer for review may result, in various embodiments, in the display of the offer. FIG. 8 illustrates an example screen image of an offer displayed after selection, the screen image created by the display module 130.

As illustrated in the example of FIG. 8, the promotional offer may display: the name of the merchant (832), the particular discount or offer being given (834), the time period during which the offer may be used (836), and the number of offers which are still left for provisioning (838). The location of the merchant may also be indicated, such as by an address and/or a marker on an associated map. In an embodiment, the number of remaining offers would immediately be reduced by one unit as an offer is reserved/purchased and may function similar to a countdown, encouraging acceptance of the offer. In various embodiments, merchants may be promoted using a spotlight merchant feature in an embodiment, such as by a promotional offer offered on a search page, such as the image of FIG. 7. In various embodiments, merchants may be highlighted by featuring the merchant on the homepage of the website, or by making a particular merchant the default location displayed on the map. In various embodiments, this highlighting could be provided for free or as paid advertising for the spotlighted business.

The display module may also provide a link, such as the “Reserve” button 840, for use if a consumer wishes to learn more or to accept the offer. The consumer may then be presented with the same and/or additional information regarding the merchant and/or the offer such as, for example, hours of operation, address, phone number, location, merchant photos, consumer or professional reviews, price of the offer, business category/categories, offer type (e.g., fixed discount amount, discounted percentage, etc.), number of discounts available, minimum and/or maximum discount amount/value, and/or category or item(s) covered by the discount.

FIG. 9 illustrates an example process 900 for the display module 130 of the promotional offer provision system 100 to provide a promotional offer to a consumer. The process may begin at operation 910, where the display module 130 may receive a selection of a promotional offer from a consumer. At operation 920, the display module 130 may then present promotional offer information for the selected offer as well as terms and conditions for accepting the offer. At operation 925, the display module determines if the consumer has accepted the offer.

If so, at operation 950, the display module provisions the offer. In one embodiment, the provisioning of the promotional offer is performed through the use of a special offer code that uniquely identifies the consumer's accepted offer. This code may take the form of a coupon or voucher. In another embodiment, instead of a coupon, a pre-purchased gift certificate sold at a discount may be offered. In one embodiment, a coupon code may comprise a unique bar code or other scannable code (such as a QR code) that can be scanned by the merchant to verify the accuracy of the code. In one embodiment, the unique code is recorded in the provisioned promotion storage 160 in order that it may be verified by a merchant later and/or accessed later by the consumer. In one embodiment, the unique code may additionally identify the consumer, such as for tracking consumer history. In various embodiments, the coupon, voucher, or gift certificate can be printed, emailed, texted or electronically delivered to the customer and used at the merchant.

If the consumer does not accept the offer at operation 925, the display module 130 determines whether counter-offers are enabled by the merchant for this particular offer. Counter-offers, in various embodiments, provide the ability for a consumer to negotiate his or her own discount or other offer rather than accept the original terms of the promotional offer. If the merchant has not indicated that counter-offers are allowed, then the process may end. However, if counter-offers are enabled, then the display module 130, at operation 940, may receive a counter-offer from the consumer. In various embodiments, the display module 130 may take advantage of a standardized offer structure, such as the examples discussed above, to allow the consumer to generate a counter-offer. In another embodiment, the consumer may be given an open-ended form for himself or herself to suggest a counter-offer. The display module may then send the counter-offer to the merchant for acceptance. In various embodiments, the display module may send the counter-offer in the form of a telephone call, voice message, text message, email message, or other computerized or non-computerized communication.

At operation 945, the display module may determine if the merchant has accepted the offer. In various embodiments, the merchant may accept the offer, reject the offer, or counter the consumer's counter-offer. If the merchant accepts the offer, the display module 130 may proceed with provisioning the offer at operation 950. If the merchant rejects the offer, the process may end. If the merchant chooses to counter with his own counter-offer, the process may then repeat where the merchant's new counter-offer is presented to the consumer at operation 920. In various embodiments, rather than require explicit counter-offer and acceptance, the display module may allow for the consumer, the merchant, or both, to set up parameters or limits to their offer and counter-offer. This may be performed at the time the offer is provided to the consumer, or may be performed during the set up of a profile or other preferences for one or both of the merchant and the consumer. In such embodiments, the display module may reconcile the limits on the offer and counter-offer and, if an agreement can be reached that is within both sets of limits, the display module may suggest a mutually-agreed-upon offer. In some embodiments, the display module may automatically accept this offer for the consumer and the merchant if one or both have indicated that the promotional offer provision system 100 may do so.

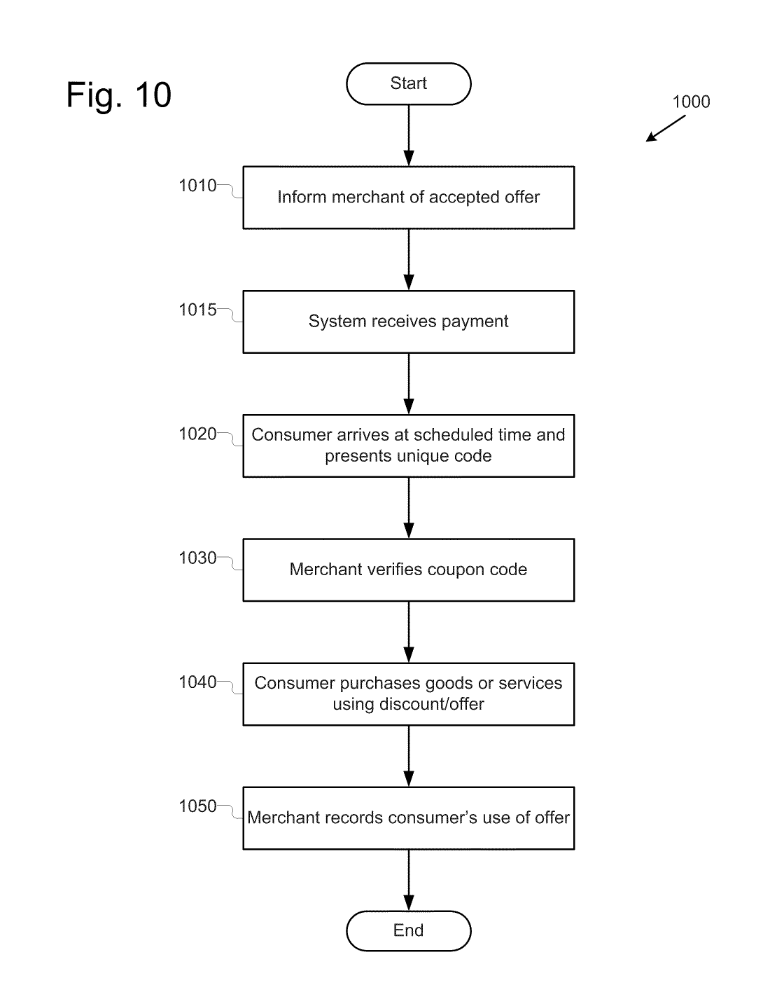

FIG. 10 illustrates an example process 1000 for a consumer using a provisioned promotional offer in accordance with various embodiments. The process may begin at operation 1010, where, after the consumer has accepted the offer, the promotional offer provision system 100 may inform the merchant that the offer was accepted and that a discount or other offer was reserved. In various embodiments, the promotional offer provision system 100 may generate a message and provide the message to the merchant in the form of an email message, facsimile, telephone call/message, text message or other alert.

At operation 1015, the promotional offer provision system 100 may receive payment for the provisioning of the offer. In one embodiment, use of the system may be free. In another, the system may include a charge to either the merchant or the consumer at a per-offer rate, for example the system may charge $1 per coupon reserved. In such a scenario, embodiments may provide for payment at an earlier stage, such as at the point the promotional offer is accepted, rather than when it is used. In yet another embodiment, the system may include a charge to either the merchant or the consumer for each offer that is used, rather than reserved. In various embodiments, the system may charge using an alternative payment method, such as promotional points.

In another embodiment, the system 100 may operate at a flat subscription cost for the merchant and/or the consumer. In yet another, the promotional offer provision system 100 may utilize a hybrid method where a subscription is charged to a merchant for a basic listing with a cost assessed per offer. In yet another embodiment, the promotional offer provision system 100 may charge a minimum amount that may then be offset (charged against) in the form of an “electronic wallet” or other such merchant account. For example the account may be drawn-down to pay a fee to the system on a per-offer basis. In various embodiments, the system may charge more for promotional offers which are given to consumers who have particular histories. In particular, if a promotional offer is made to a consumer based on his or her history, such as if the consumer is targeted as being particularly desirable, the system may charge the merchant more for the more valuable consumer.

At operation 1020, the consumer may arrive during the time period scheduled for the promotional offer and present his or her unique code. At operation 1030, the merchant may then verify the coupon code with the promotional offer provision system 100, such as through a verification interface provided by the display module 130 (not pictured). In various embodiments, the promotional offer provision system 100 may review those codes that it has recorded in the provisioned promotion storage 160 to determine if the presented code is indeed verified. In another embodiment, the merchant may establish a set of unique codes prior to scheduling promotional offers, allowing the merchant to locally verify the code presented by the consumer.

At operation 1040, the consumer may purchase goods or services from the merchant with the discount or other promotional offer being applied to the purchase. At block 1050, the merchant may record the consumer's use of the promotional offer, such as through a logging interface provided by the display module 130 (not pictured). For example, the merchant may report which consumers were “no-shows,” (i.e. which consumers did not show up). These “no-shows” would then be recorded under each consumer's profile. The information recorded at this operation may be included in the consumer's profile on the profile storage 150, where it may be used for future history-based provisioning, as discussed above. For example, merchants could determine how many “no-shows” are acceptable for their next discount offer; this information could be used to determine if a consumer could be presented with an offer.

In alternative embodiments, instead of purchasing coupons/codes outright, the promotional offer provision system 100 may permit a consumer to make a small payment as a deposit or to preserve the right to purchase offers at a later time, such as when redemption is desired. In various embodiments, the payment made as a deposit may be treated as revenue to the system 100, to the merchant, or be partitioned between the two. In various embodiments, the deposit may be used in whole or in part as an offset against the cost of the offer or against the consumer's purchase, or could be an additional payment. The process may then end.

Various embodiments may also incorporate a membership-based service. In these embodiments, a network of restaurants and retailers may agree to a standardized and/or common format for promotional offers such as happy hours and time-based discounts. The merchant participants in this network may then dedicate a portion of their business space to consumer members.

In such an embodiment, a coupon may not be used. Instead, the member may announce his or her presence at check-in and show proof of membership. The merchant may have set-up for promotions in a manner similar to that discussed above with respect to FIG. 5. For example, the merchant may create a weekly schedule based on: day of the week, time period, offer type, number of tables or units, physical space in the merchant's establishment (such as “bar” or “entire restaurant”) used for a promotion, minimum and maximum dollar amount to spend, minimum and maximum units, seats a consumer is asked to commit to, and/or other restrictions.

In various embodiments the consumer member may view the promotion, arrive at the establishment and show proof of membership. The member may then be provided with the merchant's available inventory (i.e. seated at one of the membership's available tables). Later a discount may be applied. In various embodiments, a premium membership could be added where the member could have a reservation at a first-come-first-served inventory.

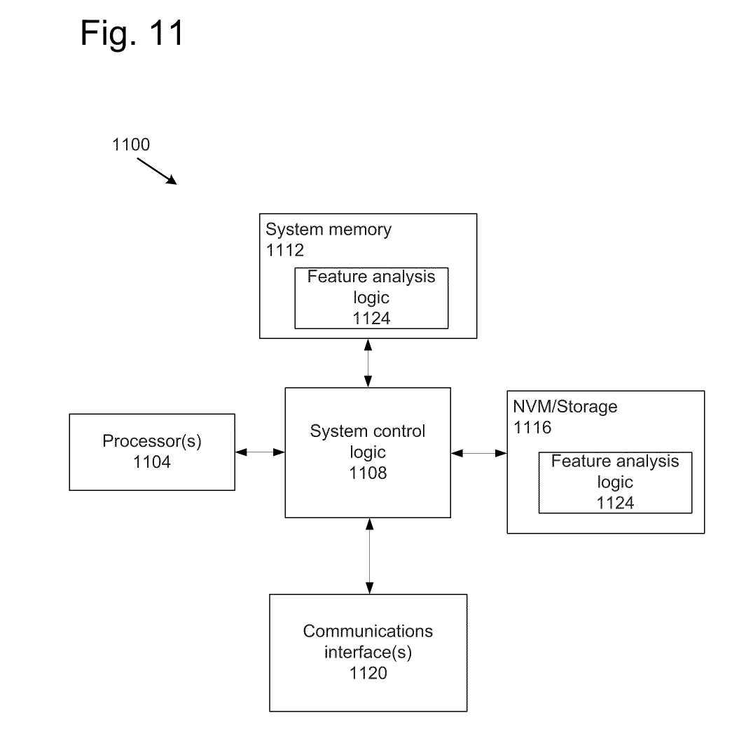

The techniques and apparatuses described herein may be implemented into a system using suitable hardware and/or software to configure as desired. FIG. 11 illustrates, for one embodiment, an example system 1100 comprising one or more processor(s) 1104, system control logic 1108 coupled to at least one of the processor(s) 1104, system memory 1112 coupled to system control logic 1108, non-volatile memory (NVM)/storage 1116 coupled to system control logic 1108, and one or more communications interface(s) 1120 coupled to system control logic 1108.

System control logic 1108 for one embodiment may include any suitable interface controllers to provide for any suitable interface to at least one of the processor(s) 1104 and/or to any suitable device or component in communication with system control logic 1108.

System control logic 1108 for one embodiment may include one or more memory controller(s) to provide an interface to system memory 1112. System memory 1112 may be used to load and store data and/or instructions, for example, for system 1100. System memory 1112 for one embodiment may include any suitable volatile memory, such as suitable dynamic random access memory (DRAM), for example.

System control logic 1108 for one embodiment may include one or more input/output (I/O) controller(s) to provide an interface to NVM/storage 1116 and communications interface(s) 1120.

NVM/storage 1116 may be used to store data and/or instructions, for example. NVM/storage 1116 may include any suitable non-volatile memory or non-transitory computer-readable media, such as flash memory, for example, and/or may include any suitable non-volatile storage device(s), such as one or more hard disk drive(s) (HDD(s)), one or more solid-state drive(s), one or more compact disc (CD) drive(s), and/or one or more digital versatile disc (DVD) drive(s) for example.

The NVM/storage 1116 may include a storage resource physically part of a device on which the system 1100 is installed or it may be accessible by, but not necessarily a part of, the device. For example, the NVM/storage 1116 may be accessed over a network via the communications interface(s) 1120.

System memory 1112 and NVM/storage 1116 may include, in particular, temporal and persistent copies of logic 1124. Logic 1124 may be configured to enable system 1100, in response to operation of the logic, to practice some or all aspects of the promotional offer provisioning techniques described earlier. In various embodiments, logic 1124 may be implemented via programming instructions of any one of a number of programming languages, including but not limited to C, C++, C#, HTML, XML, and so forth.

Communications interface(s) 1120 may provide an interface for system 1100 to communicate over one or more network(s) and/or with any other suitable device. Communications interface(s) 1120 may include any suitable hardware and/or firmware. Communications interface(s) 1120 for one embodiment may include, for example, a network adapter, a wireless network adapter, a telephone modem, and/or a wireless modem. For wireless communications, communications interface(s) 1120 for one embodiment may use one or more antenna(s).

For one embodiment, at least one of the processor(s) 1104 may be packaged together with logic for one or more controller(s) of system control logic 1108. For one embodiment, at least one of the processor(s) 1104 may be packaged together with logic for one or more controllers of system control logic 1108 to form a System in Package (SiP). For one embodiment, at least one of the processor(s) 1104 may be integrated on the same die with logic for one or more controller(s) of system control logic 1108. For one embodiment, at least one of the processor(s) 1104 may be integrated on the same die with logic for one or more controller(s) of system control logic 808 to form a System on Chip (SoC).

In various embodiments, system 1100 may have more or fewer components, and/or different architectures.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

1-36. (canceled)

37. A computer-implemented method for providing promotional offers to consumers, the method comprising:
receiving, by a computing device, a request from a user to view promotional offers;
selecting, by the computing device, one or more promotional offers out of a plurality of known promotional offers as relevant to present to the user, based at least in part on a location associated with the user; and
facilitating, by the computing device, display of the one or more selected promotional offers to the user.

38. The method of claim 37, wherein the computing device is a mobile device.

39. The method of claim 38, wherein the location is a current location of the mobile device, the current location being determined by the mobile device in response to the request by the user.

40. The method of claim 37, wherein the location associated with the user comprises a location that has been manually indicated by the user along with the request.

41. The method of claim 37, wherein facilitating display of the selected promotional offers to the user comprises facilitating, by the computing device, display of a map showing locations of promotional offers that are proximate to the location associated with the user.

42. The method of claim 37, wherein selecting one or more promotional offers comprises selecting one or more promotional offers further based at least in part on a time associated with the request.

43. The method of claim 42, wherein selecting one or more promotional offers comprises selecting, by the computing device, one or more promotional offers which are available during the time associated with the request and which are associated with locations near the location associated with the user.

44. The method of claim 42, wherein the time associated with the request comprises a time determined, by the computing device, as being contemporaneous with receipt of the request.

45. The method of claim 42, wherein the time associated with the request comprises a time that is manually input by the user.

46. The method of claim 37, wherein:
the computing device receives the request from a mobile device other than the computing device; and
facilitating display of the one or more selected promotional offers comprises facilitating, by the computing device, display of the one or more selected promotional offers on the mobile device.

47. The method of claim 37, wherein selecting one or more promotional offers further comprises selecting, by the computing device, one or more promotional offers which have a limited availability.

48. The method of claim 37, wherein selecting one or more promotional offers comprises selecting, by the computing device, the one or more promotional offers based at least in part on preferences of the user.

49. The method of claim 48, wherein the preferences of the user comprise one or more promotional offer types.

50. The method of claim 48, wherein the preferences of the user comprise a distance in which to search.

51. The method of claim 48, further comprising sending, to the user, an alert of new promotional offers without requiring a request from the user, based at least in part on the preferences of the user.

52. The method of claim 37, wherein:
the received request from the user comprises one or more search parameters; and
the selecting one or more promotional offers is further based at least on the one or more search parameters.

53. The method of claim 37, further comprising receiving, by the computing device, an acceptance of a promotional offer by the user.

54. The method of claim 53, wherein the accepted promotional offer may only be used after the promotional offer is accepted by a pre-determined number of users.

55. The method of claim 37, wherein selecting one or more promotional offers further comprises selecting, by the computing device, one or more promotional offers based at least in part on a credibility rating of the user.

56. The method of claim 37, wherein the one or more of the plurality of known promotional offers comprise coupons and/or gift certificates.

57. The method of claim 37, wherein one or more of the known promotional offers may be created contemporaneously with the receipt of the request from the user.

58. The method of claim 37, further comprising proving an interface for input of promotional offers from one or more vendors as known promotional offers.

59. A computer-implemented method for providing promotional offers to consumers, the method comprising:
receiving, by a computing device, a description of a promotional offer from a merchant, the description specifying a time period of a day during which the promotional offer may be used by consumers;
selecting, by the computing device, the promotional offer out of a plurality of received promotional offers as relevant to present to a consumer, based at least in part on a time the consumer has indicated; and
displaying, by the computing device, the promotional offer to the consumer.

60. The method of claim 59, wherein selecting the promotional offer as relevant based at least in part on a time the consumer has indicated comprises selecting the promotional offer based on a current time during which the consumer is requesting to view promotional offers.

61. The method of claim 59, wherein selecting the promotional offer as relevant based at least in part on a time the consumer has indicated comprises selecting the promotional offer based on a future time the consumer has indicated.

62. The method of claim 59, wherein selecting the promotional offer as relevant comprises selecting the promotional offer based on a location indicated by the consumer.

63. The method of claim 62, wherein displaying the promotional offer comprises displaying a map oriented on the location indicated by the consumer.

64. The method of claim 59, wherein selecting the promotional offer as relevant comprises selecting the promotional offer based an alert indicated by the consumer.

65. The method of claim 64, wherein the alert indicated by the consumer is associated with the merchant and/or with promotional preferences the consumer has previously indicated.

66. The method of claim 59, wherein selecting the promotional offer as relevant comprises selecting the relevant promotional offer based at least in part on a time period during which the relevant promotional offer is to remain live and/or how many copies of the relevant promotional offer may be made to consumers.

67. The method of claim 59, wherein selecting the promotional offer as relevant comprises selecting the offer based on preferences associated with the consumer.

68. The method of claim 59, wherein displaying the promotional offer comprises displaying an identifier for the promotional offer that identifies the consumer.

69. The method of claim 59, further comprising:
receiving a selection of the promotional offer from the consumer;
providing, by the computing device, terms and conditions for accepting the promotional offer; and
receiving, by the computing device, the consumer's acceptance of the terms and conditions.

70. The method of claim 69, further comprising:
receiving, by the computing device, a counter-offer from the consumer; and
transmitting, by the computing device, the counter-offer to the merchant.

71. The method of claim 70, further comprising receiving, by the computing device, the merchant's acceptance of the counter-offer.

72. A system for providing promotional offers to consumers, the system comprising:
one or more computer processors;
a schedule storage coupled to the processors, and configured to store a schedule describing one or more promotional offers for one or more merchants, the schedule including times of day when the promotional offers may be used;
a schedule input module, configured, in response to operation by the one or more processors, to receive from a merchant a schedule describing one or more promotional offers; and
a display module, configured, in response to operation by the one or more processors, to:
select, out of the one or more promotional offers described in the schedule store, relevant promotional offers for display to a consumer based at least in part on a time the consumer has indicated; and
display the relevant promotional offers to the consumer.

73. The system of claim 72, wherein the display module is further configured to select relevant promotional offers based on a current time and/or a current location.

74. The system of claim 72, further comprising one or more profile storages coupled to the processors and configured to store profile information about merchants and/or consumers.

75. The system of claim 72, wherein the display module is further configured to select relevant promotional offers based at least in part on information in the profile storage about consumer credibility.

76. The system of claim 72, wherein the display module is further configured to select relevant promotional offers based on information in the schedule storage about times of day when the promotional offers may be used.

77. The system of claim 72, wherein the display module is further configured to select relevant promotional offers based on information in the schedule storage about how many copies of a promotional offer may be offered.

78. An article of manufacture, comprising:
a tangible computer-readable medium; and
a plurality of computer-executable instructions stored on the tangible computer-readable medium, wherein the computer-executable instructions, in response to execution by an computing device, cause the computing device to perform operations for providing promotional offers to consumers, the operations including:
receiving a schedule describing a promotional offer from a merchant, the schedule specifying a time period of a day during which the promotional offer may be used by consumers;
selecting the promotional offer out of a plurality of promotional offers as relevant to present to the consumer based at least in part on information in the schedule, based at least in part on a time the consumer has indicated; and
displaying the promotional offer to a consumer.

79. The computer-readable media of claim 78, wherein selecting the promotional offer as relevant based at least in part on a time the consumer has indicated comprises selecting the promotional offer based on a current time during which the consumer is requesting to view promotional offers.

80. The computer-readable media of claim 78, wherein selecting the promotional offer based on information about the consumer comprises selecting the offer based on the consumer's current location.

81. The computer-readable media of claim 78 wherein said selecting the promotional offer as relevant comprises selecting the promotional offer based at least in part on information the schedule describing how many copies of the relevant promotional offer may be made to consumers.

82. The computer-readable media of claim 78, wherein selecting the promotional offer as relevant comprises additionally selecting the offer based on information about the consumer.

83. The computer-readable media of claim 82, wherein selecting the promotional offer based on information about the consumer comprises selecting the offer based on a prediction of whether the consumer will use the promotional offer.

84. The computer-readable media of claim 78, wherein the operations further include:
receiving a selection of a promotional offer from the consumer; and
providing, by the computing device, terms and conditions for accepting the promotional offer.

85. The computer-readable media of claim 84, wherein the operations further include:
receiving, by the computing device, a counter-offer from the consumer; and
transmitting, by the computing device, the counter-offer to the merchant.

86. The computer-readable media of claim 78, wherein displaying the promotional offer comprises displaying the promotional offer in a web browser or a dedicated application operated on another computing device.
